(19) United States
(12) Patent Application Publication
(10) Pub. No.: US 2017/0311032 A1
(43) Pub. Date: Oct. 26, 2017

(54) Content Identifier Remapping for Fast Channel Change

(71) Applicant: Cisco Technology, Inc., San Jose, CA (US)

(72) Inventors: Robert A. Drisko, Concord, MA (US); Joshua B. Gahm, Newton, MA (US); Andrew J. Sawchuk, Waltham, MA (US); Arivazhagan Sankaralingam, Chennai (IN); Jayaprabhu Nadarajan, Chennai (IN)

(21) Appl. No.: 15/168,007

(22) Filed: May 28, 2016

(30) Foreign Application Priority Data
Apr. 20, 2016 (IN) 20161013737

(51) Int. Cl. H04N 21/438; H04N 21/643

(52) U.S. Cl. CPC H04N 21/4384; H04N 21/64322; H04N 21/438; H04N 21/4382

(57) ABSTRACT

In one embodiment, a method includes receiving fast channel change (FCC) data for a program, the FCC data having a first set of content identifiers, receiving a video stream for the program, the video stream having a second set of content identifiers, changing at least one of the first set of content identifiers of the FCC data or the second set of content identifiers of the video stream to a common set of content identifiers, and providing the changed FCC data and video stream to a decoder.

### TECHNICAL FIELD

The present disclosure relates generally to set-top boxes, and in particular, to systems, methods and apparatuses enabling a fast channel change by a hybrid set-top box.

### BACKGROUND

The ongoing development, maintenance, and expansion of media distribution networks involve an increasing number of hybrid set-top boxes that can receive content from multiple sources (e.g., terrestrial cable, internet, and satellite). This can present a number of challenges in seamlessly streaming content from multiple sources.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a diagram of network in accordance with some implementations.

FIG. 2 is a flowchart representation of a method of performing a fast channel change in accordance with some implementations.

FIG. 3 is a flowchart representation of a method of remapping a video stream in accordance with some implementations.

FIG. 4 is a functional block diagram of a hybrid set-top box in accordance with some implementations.

FIG. 5 is a block diagram of a computing device in accordance with some implementations.

FIG. 6 is a block diagram of another computing device in accordance with some implementations.

In accordance with common practice various features shown in the drawings may not be drawn to scale, as the dimensions of various features may be arbitrarily expanded or reduced for clarity. Moreover, the drawings may not depict all of the aspects and/or variants of a given system, method or apparatus admitted by the specification. Finally, like reference numerals are used to denote like features throughout the figures.

### DESCRIPTION OF EXAMPLE EMBODIMENTS

Numerous details are described herein in order to provide a thorough understanding of the illustrative implementations shown in the accompanying drawings. However, the accompanying drawings merely show some example aspects of the present disclosure and are therefore not to be considered limiting. Those of ordinary skill in the art will appreciate from the present disclosure that other effective aspects and/or variants do not include all of the specific details of the example implementations described herein. While pertinent features are shown and described, those of ordinary skill in the art will appreciate from the present disclosure that various other features, including well-known systems, methods, components, devices, and circuits, have not been illustrated or described in exhaustive detail for the sake of brevity and so as not to obscure more pertinent aspects of the example implementations disclosed herein.

### Overview

Various implementations disclosed herein include apparatuses, systems, and methods for performing a fast channel change on a set-top box. For example, in some implementations, a method includes receiving fast channel change (FCC) data for a program, the FCC data having a first set of content identifiers, receiving a video stream for the program, the video stream having a second set of content identifiers, changing at least one of the first set of content identifiers of the FCC data or the second set of content identifiers of the video stream to a common set of content identifiers, and providing the changed FCC data and video stream to a decoder.

In other implementations, a method includes receiving, via a user interface, a channel change request indicating a channel carrying a program, tuning a QAM (Quadrature Amplitude Modulation) tuner to the channel and receiving an MPEG (Motion Picture Expect Group) transport stream for the program, requesting, from an IPTV (Internet Protocol Television) FCC (Fast Channel Change) server, FCC data for the program and receiving the FCC data for the program, generating a remapped MPEG transport stream for the program by changing content identifiers of the MPEG transport stream to those of the FCC data, and decoding the FCC data and the remapped MPEG transport stream to generate an output stream.

### Example Embodiments

As noted above, a hybrid set-top box can receive content via a number of different delivery methods. This can present a number of challenges in seamlessly streaming content from multiple sources. For example, when receiving content via an IPTV connection, the channel change time can be minimized through use of a FCC server. The FCC server can provide the initial decoder priming information (such as a PAT, PMT, and/or other program specific information) and a data burst starting with an I-frame for a channel change, prior to the set-top box receiving the content from a video head-end. In QAM-based video delivery systems, an Edge QAM multiplexes multiple programs to form a multiple program transport stream. In doing so, the Edge QAM can modify program specific information of programs, such as the packet identifier (PID) of various elementary streams, the PMT and other data tables, the program numbers, and/or other information, to values that are not conflicting with other programs in the multiple program transport stream, but are inconsistent with those of the FCC server. Described herein are apparatuses, systems, and methods for resolving this inconsistency.

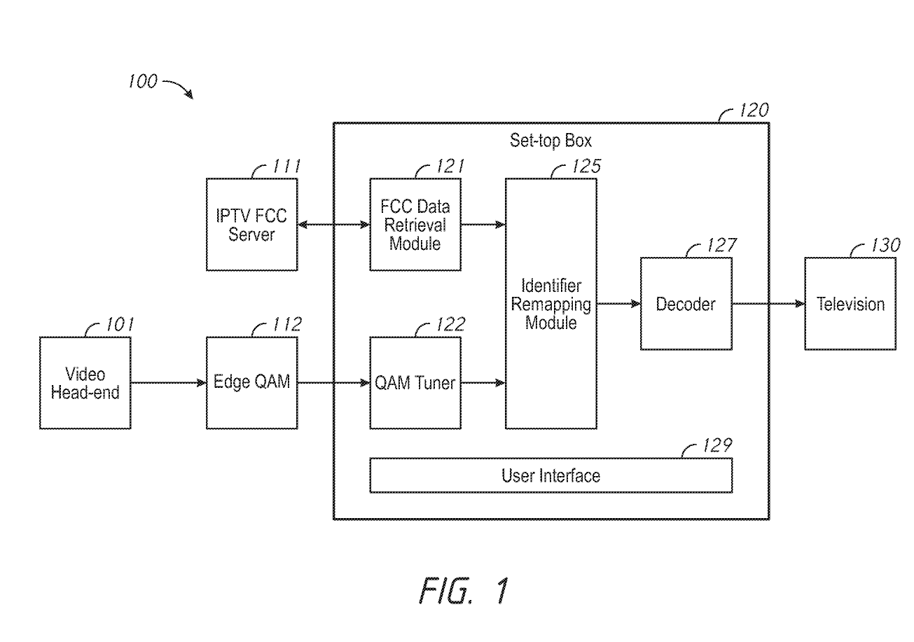

FIG. 1 is a diagram of network 100 in accordance with some implementations. The network 100 includes a video head-end 101 that receives content from one or more content providers. The video head-end 101 can perform processing of the received content, including grooming, multiplexing, transrating, ad insertion, and video encoding. In various implementations, the video head-end 101 encodes the received content as one or more MPEG (Moving Picture Expert Group) transport streams.

An MPEG transport stream includes a Program Association Table (PAT) that lists the programs within the transport stream. Each of the programs listed in the PAT is identified by a program number, typically a 16-bit value, and associated with a Program Map Table (PMT) packet identifier (PID). For each program within the transport stream, the MPEG transport stream includes a Program Map Table (PMT). The PMT for a program includes information regarding the program, including the program number and a list of elementary streams associated with the program. As an example, a program can include a video stream, a first audio stream, a second audio stream (e.g., a dubbed second language), and a textual stream (e.g., subtitles).

The MPEG transport stream includes multiple packets, each of the packets including a packet identifier (PID). Each packet of an elementary stream includes the same PID. Thus, a program can include a video stream having multiple packets including a first PID and an audio stream having multiple packets including a second PID.

The video head-end 101 provides the one or more MPEG transport streams to an IPTV (Internet Protocol Television) FCC (Fast Channel Change) server 111 and to an Edge QAM (Quadrature Amplitude Modulation) device 112. In some implementations, the Edge QAM device 112 can receive multiple MPEG transport streams having different programs identified by the same program number in their respective MPEG transport streams. For example, the Edge QAM device 112 can receive a first MPEG transport stream including a first program identified by a program number of ‘1’ and receive a second MPEG transport stream including a second program (a different program) identified by a program number of ‘1’. Similarly, the Edge QAM device 112 can receive multiple MPEG transport streams having unrelated elementary streams including the same PID. For example, the Edge QAM device 112 can receive a first MPEG transport stream including a first program having a video stream having multiple packets including a PID of ‘0x1A’ and receive a second MPEG transport stream including a second program (a different program) having an audio stream having multiple packets including a PID of ‘0x1A’.

The Edge QAM device 112 can generate a multiplexed output stream including multiple programs from multiple MPEG transport streams by assigning each program in the multiplexed output stream a unique program number and each elementary stream in the multiplexed output stream a unique PID. The unique program number for a program and/or unique PID for an elementary stream may be different in the multiplexed output stream than that of the input stream.

The network 100 further includes a set-top box 120. The set-top box 120 receives the multiplexed output stream (also, in various implementations, an MPEG transport stream) transmitted by the Edge QAM device 112. The set-top box 120 includes a QAM tuner 122 that receives the multiplexed output stream and, based on the channel to which the QAM tuner 122 is tuned, extracts a single program from the multiplexed output stream.

The set-top box 120 includes a user interface 129 configure to receive input from a user. The user interface 129 can include physical components, such as one or more buttons or an infrared or Bluetooth receiver for receiving input from a remote control. The user interface 129 can include a processing device executing an electronic program guide (EPG).

When the set-top box 120 receives a channel change request via the user interface 129, to change channels from a first channel (a current channel) to a second channel (a new channel) the set-top box 120 reconfigures the QAM tuner 122 to extract a program associated with the new channel. In various implementations, the set-top box 120 tunes the QAM tuner 122 to a frequency associated with the new channel.

The channel change request can be received in response to a number of different actions. For example, the channel change request can be received in response to a user pressing a channel up or channel down button on the set-top box or a remote control. The channel change request can be received in response to a user inputting a channel number into a remote control. The channel change request can be received in response to a user selecting a program via an EPG.

When the set-top box 120 receives the channel change request, in addition to reconfiguring the QAM tuner 122, the set-top box 120 configures an FCC data retrieval module 121 to transmit a request to the IPTV FCC server 111 for fast channel change (FCC) data for the program associated with the new channel. In various implementations, the FCC data can be implemented as an MPEG transport stream. In response, the FCC data retrieval module 121 receives the FCC data from the IPTV FCC server 111.

The FCC data can include, for example, decoder priming information and a data burst starting with an I-frame. An I-frame (or Intra-frame) can be decoded independently of any other frames in the video stream. Accordingly, the set-top box 120 does not need to wait for the MPEG transport stream received by the QAM tuner 122 to include an I-frame before decoding the program. The decoder priming information can include, for example, a PAT, PMT, and other program specific information.

In various implementations, the FCC data received for the program via the FCC data retrieval module 121 and the MPEG transport stream received for the program via the QAM tuner 122 can have different program numbers for the program and/or different PIDs for elementary streams of the program. As described above, the Edge QAM device 112 can, at times, change the program numbers and/or PIDs when generating a multiplexed output stream.

As an example, the video head-end 101 can transmit an MPEG transport stream including a program identified by a program number of ‘1’ and including a video stream having packets including a PID of ‘0x1A’ and including an audio stream having packets including a PID of ‘0x1B’. The FCC server 111 receives this MPEG transport stream and, in response to a channel change request, transmits FCC data based on the MPEG transport stream to the FCC data retrieval module 121. Thus, the FCC data retrieval module 121 of the set-top box 120 receives packets of the video stream of the program including a PID of ‘0x1A’ and packets of the audio stream of the program including a PID of ‘0x1B’. The Edge QAM device 112, in generating the multiplexed output stream, can change the program number of the program to ‘2’ and the PIDs of the video stream and audio stream to ‘0x10’ and ‘0x11’, respectively. Thus, the QAM tuner 122 of the set-top box receives packets of the video stream of the program including a PID of ‘0x10’ and packets of the audio stream of the program including a PID of ‘0x11’.

When data received for the program via the FCC data retrieval module 121 and the data received for the program via the QAM tuner 122 have different program numbers for the program and/or different PIDs for elementary streams of the program, the decoder 127 may be unable to decode the packets into a single output stream. In particular, once the decoder 127 receives packets with modified PIDs from the Edge QAM device 112, the decoder 127 simply ignores them (as they are unknown to the decoder) until the decoder 127 learns the new modified PIDs from the PAT and PMT of the program received from the Edge QAM device 112. This can cause a temporary interruption in the video playback (like freeze frame). Accordingly, the set-top box 120 includes an identifier remapping module 125 to resolve this issue. In various implementations, the identifier remapping module 125 allows a seamless transition between the FCC data and the Edge QAM data at any point in the streams without a glitch or interruption of smooth playback.

The identifier remapping module 125 changes the content identifiers (e.g., the program number, the PAT, PMT PID, elementary stream PIDs, and/or other data PIDs) within the packets received from the FCC data retrieval module 121 and the QAM tuner 122 to match. In various implementations, the identifier remapping module 125 changes the content identifiers within the packets received from the QAM tuner 122 to those of the packets received from the FCC data retrieval module 121.

Thus, in some implementations, the identifier remapping module 125 receives the FCC data from the FCC data retrieval module 121 and parses the PAT and PMT therein to determine the program number of the program and the PIDs of the various elementary streams. The identifier remapping module 125 receives an MPEG transport stream for the program from the QAM tuner 122 and parses the PAT and PMT therein to determine the changed (by the Edge QAM device 112) program number of the program and the changed PIDs of the elementary streams. The identifier remapping module 125 generates a remapped MPEG transport stream for the program by changing the content identifiers therein to match those of the FCC data. In various implementations, this includes changing the changed program number to the program number (received with the FCC data) and changing the changed PIDs of the elementary streams (including the changed PIDs included with individual packets) to those received with the FCC data.

As an example, the FCC data received from the FCC data retrieval module 121 can include a PMT for a program identified by a program number of ‘1’ and listing a first elementary stream with a PID of ‘0x1A’ and a second elementary stream with a PID of ‘0x1B’. The MPEG transport stream received from the QAM tuner 122 can include a PMT for a program identified by a program number of ‘2’ and listing a first elementary stream with a PID of ‘0x10’ and a second elementary stream with a PID of ‘0x11’. The identifier remapping module 125 can generate a remapped MPEG transport stream including a PMT for the program identified by the program number ‘1’ and listing a first elementary stream with a PID of ‘0x1A’ and a second elementary stream with a PID of ‘0x1B’. The identifier remapping module 125 can further generate the remapped MPEG transport stream by changing the PID of packets including a PID of ‘0x10’ to include a PID of ‘0x1A’ and changing the PID of packets including a PID of ‘0x11’ to include a PID of ‘0x1B’.

The identifier remapping module 125 provides the FCC data and the remapped MPEG transport stream to the decoder 127. Thus, the decoder 127 receives packets from FCC data and the remapped MPEG transport that include the same PID for the same elementary streams. Thus, the decoder 127 can decode the FCC data and the remapped MPEG transport stream together to generate an output stream that can be played by the television 130 (or other media player).

In some implementations, the identifier remapping module 125 can be enabled or disabled via an optional configurable parameter in a configuration file. When the parameter is set to TRUE, it enables the identifier remapping module 125. When the parameter is set to FALSE, the identifier remapping module 125 is disabled and, optionally, logs a warning message to a user indicating that there may be potential artifacts (such as freeze frame) in the video at channel change.

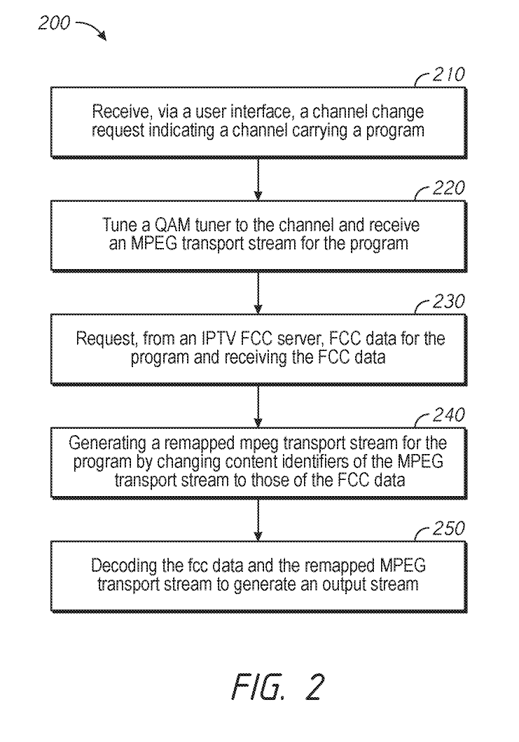

FIG. 2 is a flowchart representation of a method 200 of performing a fast channel change in accordance with some implementations. In some implementations (and as detailed below as an example), the method 200 is performed by a set-top box, such as the set-top box 120 of FIG. 1. In some implementations, the method 200 is performed by processing logic, including hardware, firmware, software, or a combination thereof. In some implementations, the method 200 is performed by a processor executing code stored in a non-transitory computer-readable medium (e.g., a memory). Briefly, the method 200 includes receiving a channel change request, receiving an MPEG transport stream (e.g., from a video head-end) and fast channel change (FCC) data for the new channel (e.g., from an FCC server), generating a remapped MPEG transport stream, and decoding the FCC data and the remapped MPEG transport stream.

The method 200 begins, at block 210, with the set-top box receiving, via a user interface, a channel change request indicating a channel carrying a program. The channel change request can be received in a number of ways. For example, the channel change request can be received in response to a user pressing a channel up or channel down button on the set-top box or a remote control. The channel change request can be received in response to a user inputting a channel number into a remote control. The channel change request can be received in response to a user selecting the program via an EPG.

At block 220, in response to receiving the channel change request, the set-top box tunes a QAM tuner to the channel and receives an MPEG transport stream for the program. In various implementations, the set-top box receives the MPEG transport stream from a video head-end. In various implementations, the set-top box tunes the QAM tuner to a frequency associated with the channel.

At block 230, also in response to receiving the channel change request, the set-top box requests, from an IPTV FCC server, FCC data for the program and, thus, receives the FCC data for the program. In various implementations, the set-top box can receive the FCC data for the program before the set-top box receives the MPEG transport stream for the program. In particular, the set-top box can receive an I-frame included in the FCC data from the IPTV FCC server before receiving an I-frame included in the MPEG transport stream from the video head-end.

In various implementations, the FCC data includes decoder priming information (e.g., PAT, PMT, ECM, PCR, etc.) and a data burst including an I-frame. The data burst can include packets of video data and/or audio data. In various implementations, the FCC data can be implemented as an MPEG transport stream.

At block 240, the set-top box generates a remapped MPEG transport stream for the program by changing content identifiers of the MPEG transport stream to those of the FCC data. As described above, the FCC data can include a PMT including information about the program, such as a program number and a list of elementary streams included in the program identified by a PID. The MPEG transport stream can include a similar PMT including information about the program, but with a different program number and a list of elementary streams included in the program number identified by different PIDs.

The set-top box can generate the remapped MPEG transport stream by changing one or more of the PMT, the program number, or the PIDs (including those of individual packets) to match those of the FCC data.

At block 250, the set-top box decodes the FCC data and the remapped MPEG transport stream to generate an output stream that can be played by a television. In particular, the output stream can include decoded (or unencoded) video and/or audio data.

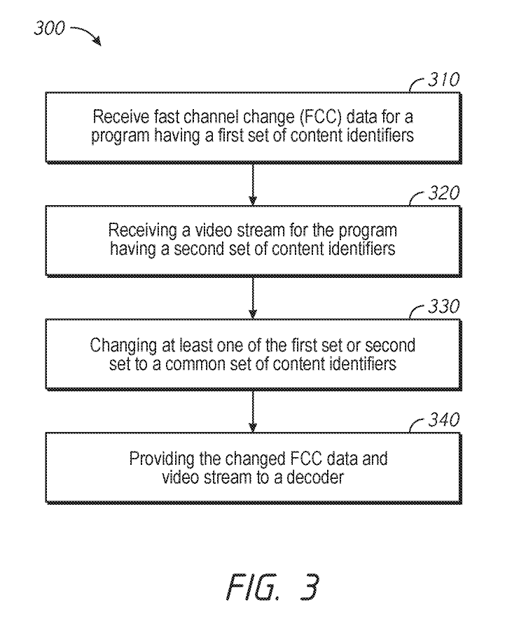

FIG. 3 is a flowchart representation of a method 300 of remapping a video stream in accordance with some implementations. In some implementations (and as detailed below as an example), the method 300 is performed by an identifier remapping module, such as the identifier remapping module 125 of FIG. 1. In some implementations, the method 300 is performed by processing logic, including hardware, firmware, software, or a combination thereof. In some implementations, the method 300 is performed by a processor executing code stored in a non-transitory computer-readable medium (e.g., a memory). Briefly, the method 300 includes receiving fast channel change (FCC) data for a program having a first set of content identifiers and a video stream for the program having a second set of identifiers, changing at least one of the first set or second set to a common set of content identifiers, and providing the FCC data and the video stream to a decoder.

The method 300 begins, at block 310, with the identifier remapping module receiving fast channel change (FCC) data for a program, the FCC data having a first set of content identifiers. In some implementations, as described above, the FCC data can be received in response to a request for the FCC data for a program, the request being sent in response to a channel change request. As described above, in some implementations, the FCC data is received via an IP connection from an IPTV FCC server.

The FCC data can include, among other things, decoder priming information and a data burst including an I-frame. The data burst can include a number of packets, including a metadata packet that includes metadata about the program, such as a program number and a list of elementary streams included in the program. The metadata can further include a PID associated with each of the elementary streams included in the program. Thus, the first set of content identifiers can include at least one of a program number or a PID. The number of packets of the data burst can also include data packets including encoded video or audio data. Each of the data packets can include a PID identifying the elementary stream to which the data packet belongs.

At block 320, the identifier remapping module receives a video stream for the program, the video stream having a second set of content identifiers. In some implementations, as described above, the video stream can be received from a QAM tuner in response to a channel change request that tunes the QAM tuner to a channel carrying the program. As described above, the video stream (which can be, for example, an MPEG transport stream), is received via a cable connection from an Edge QAM device.

The video stream can include a number of packets, including a metadata packet that includes metadata about the program, such as a program number and a list of elementary streams included in the program. The metadata can further include a PID associated with each of the elementary streams included in the program. Thus, the second set of content identifiers can include at least one of a program number or a PID. In various implementations, as described above, although the program of the video stream is the same program as the FCC data, the program number and PIDs can be different. Thus, the second set of content identifiers can be different than the first set of content identifiers. The number of packets of the data burst can also include data packets including encoded video or audio data. Each of the data packets can include a PID identifying the elementary stream to which the data packet belongs.

At block 330, the identifier remapping module changes at least one of the first set of content identifiers or the second set of content identifiers to a common set of content identifiers. In some implementations, the identifier remapping module changes the second set of content identifiers to the first set of content identifiers. In other words, the identifier remapping module replaces each of the second set of content identifiers in the video stream with the corresponding one of the first set of content identifiers in the FCC data. Thus, in some implementations, the identifier remapping module parses a PMT of the FCC data and a PMT of the video stream to determine the correspondence between the first set of identifiers and the second set of identifiers.

In some implementations, replacing each of the second set of identifiers with a corresponding one of the first set of content identifiers includes changing a metadata packet of the video stream (e.g., a PMT included in a metadata packet). In some implementations, replacing each of the second set of identifiers with a corresponding one of the first set of content identifiers includes changing a plurality of data packet of the video stream (e.g., the PID included in each of the plurality of data packets).

In some implementations, the identifier remapping module changes the first set of content identifiers to those of the second set of content identifiers. In some implementations, the identifier remapping module changes both the first set of content identifiers and the second set of content identifiers to a default set of content identifiers.

At block 340, the identifier remapping module provides the changed combination of FCC data and video stream to a decoder. In some implementations, the FCC data is unchanged and the video stream is changed (e.g., by replacing the second set of content identifiers with the first set of content identifiers). In some implementations, both the FCC data and the video stream are charged (e.g., by replacing both the first set of content identifiers and the second set of content identifiers with a default set of content identifiers).

In some implementations, the identifier remapping module provides the FCC data to the decoder before providing the video stream. For example, the identifier remapping module can provide the FCC data, unchanged, to the decoder before receiving the video stream or while changing the second set of content identifiers of the video stream.

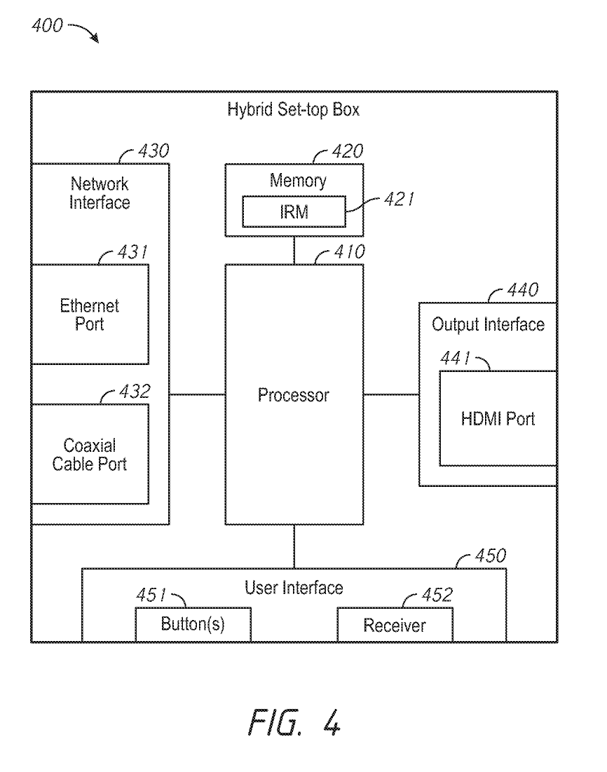

FIG. 4 is a functional block diagram of a hybrid set-top box 400 in accordance with some implementations. The hybrid set-top box includes a processor 410 and a memory 420. The memory 420 stores instructions which, when executed by the processor 410, cause the set-top box to perform the functions of an identifier remapping module 421 such as the method 300 of FIG. 3. In general, the hybrid set-top box 400 can be configured to perform the method 200 of FIG. 2 or any other methods described herein.

The hybrid set-top box 400 includes a network interface 430 for transmitting and receiving data over a network. In various implementations, the network interface 430 includes an Ethernet port 431 over which an IP connection can be established. The hybrid set-top box 400 can receive FCC data from an IPTV FCC server via the Ethernet port 431. In various implementations, the network interface 430 includes a coaxial cable port 432 over which a cable connection can be established. The hybrid set-top box 400 can receive an MPEG transport stream from an Edge QAM device via the coaxial cable port 432. The network interface 430 can include additional components, such as a tuner or a demodulator.

The hybrid set-top box 400 includes an output interface 440 for providing an output audiovisual stream. In various implementations, the output interface includes an HDMI (High Definition Multimedia Interface) port for establishing an HDMI connection with a media player, such as a television. In some implementations, the output interface 440 includes a separate audio interface and video interface.

The hybrid set-top box 400 includes a user interface 450 for receiving instructions from a user, such as a channel change request. In various implementations, the user interface 450 includes one or more buttons 451. In various implementations, the user interface 450 includes a wireless receiver 452, such as an infrared receiver or a Bluetooth receiver, for receiving instructions from a user via a remote control.

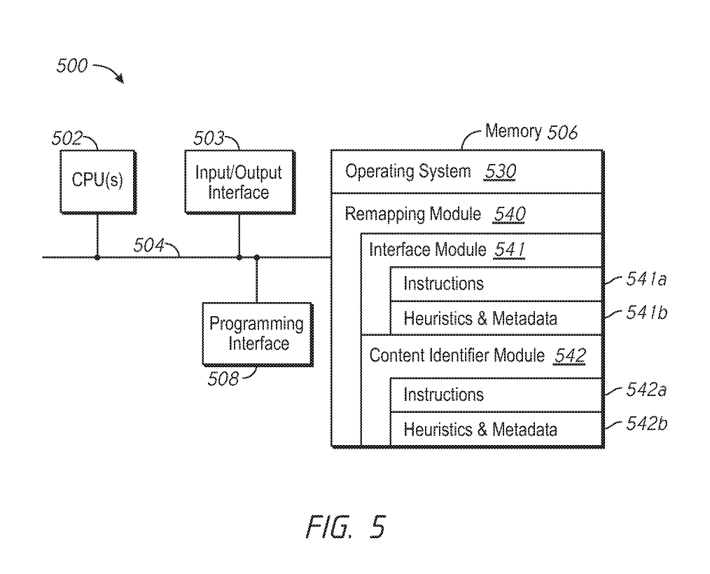

FIG. 5 is a block diagram of a computing device 500 in accordance with some implementations. In some implementations, the computing device 500 corresponds to the set-top box 120 of FIG. 2 or the set-top box 400 of FIG. 4 and performs one or more of the functionalities described above with respect to the set-top box 120 or set-top box 400. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the computing device 500 includes one or more processing units (CPU's) 502 (e.g., processors), one or more input/output interfaces 503 (e.g., a network interface and/or an output audiovisual interface), a memory 506, a programming interface 508, and one or more communication buses 504 for interconnecting these and various other components.

In some implementations, the communication buses 504 include circuitry that interconnects and controls communications between system components. The memory 506 includes high-speed random access memory, such as DRAM, SRAM, DDR RAM or other random access solid state memory devices; and, in some implementations, include non-volatile memory, such as one or more magnetic disk storage devices, optical disk storage devices, flash memory devices, or other non-volatile solid state storage devices. The memory 506 optionally includes one or more storage devices remotely located from the CPU(s) 502. The memory 506 comprises a non-transitory computer readable storage medium. Moreover, in some implementations, the memory 506 or the non-transitory computer readable storage medium of the memory 506 stores the following programs, modules and data structures, or a subset thereof including an optional operating system 530 and a remapping module 540. In some implementations, one or more instructions are included in a combination of logic and non-transitory memory. The operating system 530 includes procedures for handling various basic system services and for performing hardware dependent tasks. In some implementations, the remapping module 540 is configured to remap a video stream. To that end, the remapping module 540 includes an interface module 541 and a content identifier module 542.

In some implementations, the interface module 541 is configured to receive fast channel change (FCC) data for a program, the FCC data having a first set of content identifiers. In some implementations, the interface module 541 is further configured to receive a video stream for the program, the video stream having a second set of content identifiers. To that end, the interface module 541 includes a set of instructions 541a and heuristics and metadata 541b. In some implementations, the content identifier module 542 is configured to change at least one of the first set of content identifiers (of the FCC data) or the second set of content identifiers (of the video stream) to a common set of content identifiers. To that end, the content identifier module 542 includes a set of instructions 542a and heuristics and metadata 542b. In some implementations, the interface module 541 is configured to provide the changed FCC data and video stream (e.g., one or both of the FCC data or video stream are changed) to a decoder.

Although the remapping module 540, the interface module 541, and the content identifier module 542 are illustrated as residing on a single computing device 500, it should be understood that in other embodiments, any combination of the remapping module 540, the interface module 541, and the content identifier module 542 reside in separate computing devices in various implementations. For example, in some implementations each of the remapping module 540, the interface module 541, and the content identifier module 542 reside on a separate computing device or in the cloud.

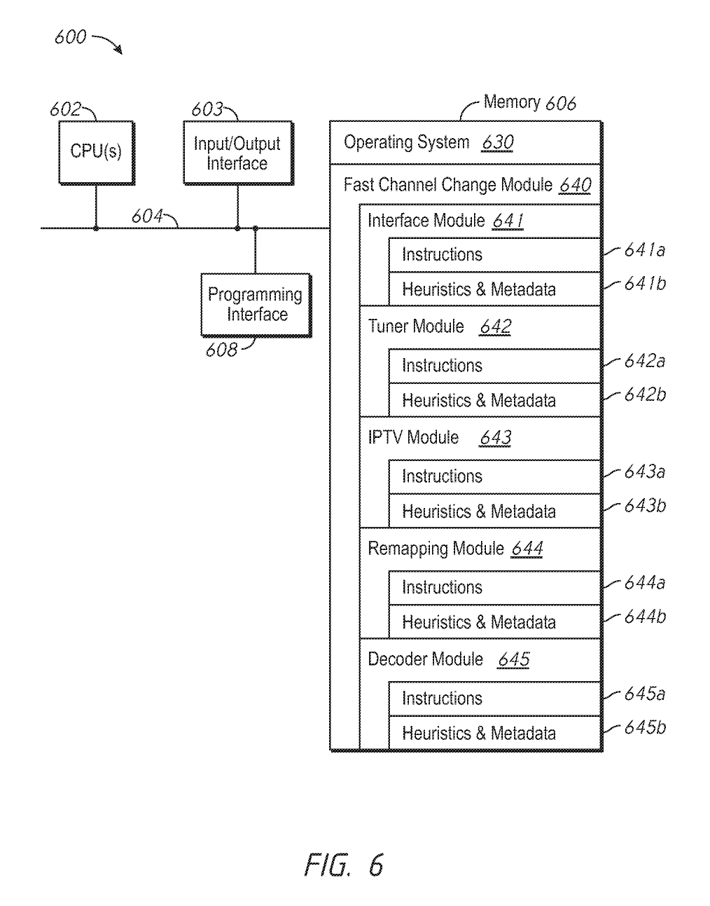

FIG. 6 is block diagram of another computing device 600 in accordance with some implementations. In some implementations, the computing device 600 corresponds to the set-top box 120 of FIG. 2 or the set-top box 400 of FIG. 4 and performs one or more of the functionalities described above with respect to the set-top box. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the computing device 600 includes one or more processing units (CPU's) 602 (e.g., processors), one or more input/output interfaces 603 (e.g., a network interface, a user interface, or an output audiovisual interface), a memory 606, a programming interface 608, and one or more communication buses 604 for interconnecting these and various other components.

In some implementations, the communication buses 604 include circuitry that interconnects and controls communications between system components. The memory 606 includes high-speed random access memory, such as DRAM, SRAM, DDR RAM or other random access solid state memory devices; and, in some implementations, include non-volatile memory, such as one or more magnetic disk storage devices, optical disk storage devices, flash memory devices, or other non-volatile solid state storage devices. The memory 606 optionally includes one or more storage devices remotely located from the CPU(s) 602. The memory 606 comprises a non-transitory computer readable storage medium. Moreover, in some implementations, the memory 606 or the non-transitory computer readable storage medium of the memory 606 stores the following programs, modules and data structures, or a subset thereof including an optional operating system 630 and a fast channel change module 640. In some implementations, one or more instructions are included in a combination of logic and non-transitory memory. The operating system 630 includes procedures for handling various basic system services and for performing hardware dependent tasks. In some implementations, the fast channel change module 640 is configured to perform a fast channel change. To that end, the fast channel change module 640 includes an interface module 641, a tuner module 642, an IPTV module 643, a remapping module 644, and a decoder module 645.

In some implementations, the interface module 641 is configured to receive a channel change request indicating a channel carrying a program. The channel change request can be received via a user interface of the input/output interface 603. To that end, the interface module 641 includes a set of instructions 641a and heuristics and metadata 641b. In some implementations, the tuner module 642 is configured to tune a QAM tuner to the channel and receive an MPEG transport stream for the program. To that end, the tuner module 642 includes a set of instructions 642a and heuristics and metadata 642b. In some implementations, the IPTV module 643 is configured to request, from an IPTV FCC server, FCC data for the program and receive the FCC data for the program. To that end, the IPTV module 643 includes a set of instructions 643a and heuristics and metadata 643b. In some implementations, the remapping module 644 is configured to generate a remapped MPEG transport stream for the program by changing content identifiers of the MPEG transport stream to those of the FCC data. To that end, the remapping module 644 includes a set of instructions 644a and heuristics and metadata 644b. In some implementations, the decoder module 645 is configured to decode the FCC data and the remapped MPEG transport stream to generate an output stream. To that end, the decoder module 645 includes a set of instructions 645a and heuristics and metadata 645b.

Although the fast channel change module 640, the interface module 641, the tuner module 642, the IPTV module 643, the remapping module 644, and the decoder module 645 are illustrated as residing on a single computing device 600, it should be understood that in other embodiments, any combination of the fast channel change module 640, the interface module 641, the tuner module 642, the IPTV module 643, the remapping module 644, and the decoder module 645 reside in separate computing devices in various implementations. For example, in some implementations each of the fast channel change module 640, the interface module 641, the tuner module 642, the IPTV module 643, the remapping module 644, and the decoder module 645 reside on a separate computing device.

Moreover, FIGS. 5 and 6 are intended more as functional description of the various features which are present in a particular implementation as opposed to a structural schematic of the embodiments described herein. As recognized by those of ordinary skill in the art, items shown separately could be combined and some items could be separated. For example, some functional modules shown separately in FIGS. 5 and 6 could be implemented in a single module and the various functions of single functional blocks could be implemented by one or more functional blocks in various embodiments. The actual number of modules and the division of particular functions and how features are allocated among them will vary from one embodiment to another, and may depend in part on the particular combination of hardware, software and/or firmware chosen for a particular embodiment.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. A method comprising:
receiving fast channel change (FCC) data for a program, the FCC data having a first set of content identifiers;
receiving a video stream for the program, the video stream having a second set of content identifiers;
changing at least one of the first set of content identifiers of the FCC data or the second set of content identifiers of the video stream such that both the FCC data for the program and the video stream for the program have a common set of content identifiers; and
providing both the FCC data for the program and the video stream for the program having the common set of content identifiers to a decoder.

2. The method of claim 1, wherein the FCC data includes decoder priming information and a data burst including an I-frame.

3. (canceled)

4. The method of claim 1, wherein the FCC data is received via an IP connection and the video stream is received via a cable connection.

5. The method of claim 1, wherein the first set of content identifiers includes at least one of a program number and one or more packet identifiers (PIDs).

6. The method of claim 1, wherein changing at least one of the first set or second set includes changing the second set by replacing each of the second set of content identifiers with a corresponding one of the first set of content identifiers.

7. The method of claim 6, further comprising parsing a program map table (PMT) of the FCC data and parsing a PMT of the video stream to determine the correspondence between the first set of identifiers and the second set of identifiers.

8. The method of claim 6, wherein replacing each of the second set of content identifiers with a corresponding one of the first set of content identifiers includes changing at least one of a metadata packet or a plurality of data packets of the video stream.

9. (canceled)

10. The method of claim 1, further comprising receiving a channel change request indicating a channel carrying the program, wherein receiving the FCC data and receiving the video stream are performed in response to receiving the channel change request.

11. The method of claim 10, further comprising transmitting a request for the FCC data in response to receiving the channel change request and tuning a tuner to the channel in response to receiving the channel change request.

12. The method of claim 1, further comprising decoding both the FCC data for the program and video stream for the program having the common set of content identifiers to generate a decoded output stream and providing the decoded output stream to a media player.

13. A system comprising:
a network interface;
one or more processors; and
a non-transitory memory comprising instructions that when executed cause the one or more processors to perform operations comprising:
receiving, via the network interface, fast channel change (FCC) data for a program, the FCC data having a first set of content identifiers;
receiving, via the network interface, an video stream for the program, the video stream having a second set of content identifiers;
changing at least one of the first set of content identifiers of the FCC data or the second set of content identifiers of the video stream such that both the FCC data for the program and the video stream for the program have a common set of content identifiers; and
providing both the FCC data for the program and the video stream for the program having the common set of content identifiers to a decoder.

14. The system of claim 13, further comprising an output audiovisual interface, the operations further comprising decoding the FCC data for the program and video stream for the program having the common set of content identifiers to generate an output stream that is output via the output audiovisual interface.

15. The system of claim 13, wherein the network interface includes an Ethernet interface and a coaxial cable interface, wherein the FCC data is received via the Ethernet interface and the video stream is received via the coaxial cable interface.

16. The system of claim 13, wherein the first set of content identifiers includes at least one of a program number and one or more packet identifiers (PIDs).

17. The system of claim 13, wherein changing at least one of the first set or second set includes changing the second set by replacing each of the second set of content identifiers with a corresponding one of the first set of content identifiers.

18. The system of claim 13, further comprising a user interface, the operations further comprising receiving a channel change request via the user interface, wherein the FCC data and the video stream are received in response to the channel change request.

19. A method comprising:
receiving, via a user interface, a channel change request indicating a channel carrying a program;
tuning a QAM (Quadrature Amplitude Modulation) tuner to the channel and receiving an MPEG (Motion Picture Expect Group) transport stream for the program;
requesting, from an IPTV (Internet Protocol Television) FCC (Fast Channel Change) server, FCC data for the program and receiving the FCC data for the program;
generating a remapped MPEG transport stream for the program by changing content identifiers of the MPEG transport stream to those of the FCC data; and
decoding the FCC data and the remapped MPEG transport stream to generate an output stream.

20. The method of claim 19, wherein the content identifiers of the MPEG transport stream include at least one of a program number or a packet identifier (PID).

21. The method of claim 19, wherein the MPEG transport stream is a multiplexed output stream including the program and at least one other program, wherein the program in the MPEG transport stream is associated with a first set of content identifiers that have been changed to be different than a second set of content identifiers of the program in the FCC data.

22. The method of claim 1, wherein the first set of content identifiers includes a first plurality of different content identifiers, the second set of content identifiers includes a second plurality of different content identifiers, and the common set of content identifiers includes a third plurality of different content identifiers.
